(19) United States
(12) Patent Application Publication
(10) Pub. No.: US 2010/0114615 A1
(43) Pub. Date: May 6, 2010

(54) OPTIMIZED INVENTORY SELECTION

(76) Inventors: Sandipan Ganguly, Bothell, WA (US); Daniel Mark Lynn, Seattle, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/498,324

(22) Filed: Jul. 6, 2009

Related U.S. Application Data
(60) Provisional application No. 61/112,136, filed on Nov. 6, 2008.

(51) Int. Cl. G06Q 10/00; G06Q 50/00; G06N 5/02; G06F 17/30

(52) U.S. Cl. 705/5; 705/10; 705/28; 706/52; 707/E17.044; 707/E17.017

(57) ABSTRACT

Systems and methods for electronically ranking records of inventory items are provided. Inventory items satisfying search criteria are electronically identified and ranked according to an inventory score calculated from a function comprising inventory attribute values of the inventory items and weighting values corresponding to the inventory attributes. The scored inventory may be further displayed to a user, such as a user that electronically submits the search criteria. The attribute values may include inventory item characteristics perceptible to users of the inventory items. The weighting values may be generated from a discrete choice model employing a conditional logit function fit to training data. The inventory score function may further include a long term function that numerically represents inventory items characteristic that are not perceptible to users of the inventory items. The disclosed embodiments may be applied to inventory including, but not limited to, travel inventory, such as hotels.

### CROSS-REFERENCE TO RELATED APPLICATION

This application claims the benefit of U.S. Provisional Application No. 61/112,136, filed Nov. 6, 2008, the entirety of which is incorporated herein by reference.

### BACKGROUND

### Description of the Related Art

Data networks, such as the Internet, have become an increasingly popular mechanism for making retail and business purchases. Advances in technology have allowed large catalogs of inventory to be made available for searching and viewing, facilitating the selection and purchase of inventory items. As a result, industries such as autos, books, electronics, tickets, travel, and others now consider network originated sales to be an important sales channel.

This revolution in sales is not without problems, however. While inventory catalogs have been made searchable, search results are often not displayed in any order of relevance to the consumer, requiring an investment of time and resources by the consumer to identify possible items for purchase, and may result in loss of potential sales. To address such issues, technologies have been developed that allow users to rank inventory search results on the basis of criteria such as price or user ratings (e.g., 1-5 stars).

One problem with this approach, among others, is the assumption that search results ranked in this manner will have greater relevance to the consumer viewing the ranked inventory, and result in higher purchase rates of inventory items, than search results not ranked in this manner. Furthermore, even assuming that higher purchase rates result from such ranking, there is no guarantee that the profits of the seller will rise in response, as the per unit profit of inventory items may vary significantly.

### BRIEF DESCRIPTION OF THE DRAWINGS

The foregoing aspects and many of the attendant advantages of the disclosed embodiments may become more readily appreciated by reference to the following detailed description, when taken in conjunction with the accompanying drawings.

FIG. 1 is a block diagram of one embodiment of an operating environment for ranking of electronically stored records of inventory items satisfying search criteria;

FIGS. 2A and 2B are block diagrams illustrating the operation of an inventory retrieval and ranking service within the operating environment of FIG. 1;

FIGS. 3A and 3B are embodiments of illustrative user interfaces generated by the inventory ranking service that assist a user of the service in submission of search criteria and display of ranked search results; and

FIG. 3C is an embodiment of an illustrative user interface generated by the inventory ranking service that may be employed to determine how the rank of an inventory item changes with modification of parameters used to calculate inventory score.

### DETAILED DESCRIPTION

Embodiments of the present disclosure provide systems and methods for electronically ranking records of inventory items. Such inventory item records may also be referred to interchangeably herein as “inventory items” or “records.” One or more inventory items that satisfy inventory search criteria are identified from a set of inventory items and an inventory score is generated for each of the identified inventory items. The inventory items are further ranked in an order determined by the generated inventory score. The ranked inventory items may be stored for future reference and/or display to a user of the system. In certain embodiments, the inventory score generated for an identified inventory item may be calculated as the product of a margin of the inventory item and a purchase likelihood value that numerically represents a preference for purchasing the inventory item as compared with the other identified inventory items.

In other embodiments, the inventory score function employed to calculate the inventory score may further include a long term factor (LTF). As discussed herein, inventory scores incorporating the long term factor may be referred to as adjusted inventory scores, while inventory scores not incorporating the long term factor may be referred to as inventory scores. The long term factor numerically represents considerations of inventory items that are not perceptible to the user and, therefore, not accounted for within the inventory score. The adjusted inventory score may be employed in lieu of the inventory score for ranking inventory items so as to adjust the placement of one or more inventory items for higher or lower prominence in order to, respectively, encourage or discourage user selection of inventory items.

Embodiments of the inventory items may include travel inventory. Examples of travel inventory may include, but are not limited to, lodging inventory (e.g., hotels), automobile rentals, air travel, cruises, and packages comprising any combination thereof. It may be understood, however, that travel inventory represent one possible embodiment of inventory items that may be identified and ranked according to the disclosed embodiments and should not be construed to limit the scope of the disclosed embodiments.

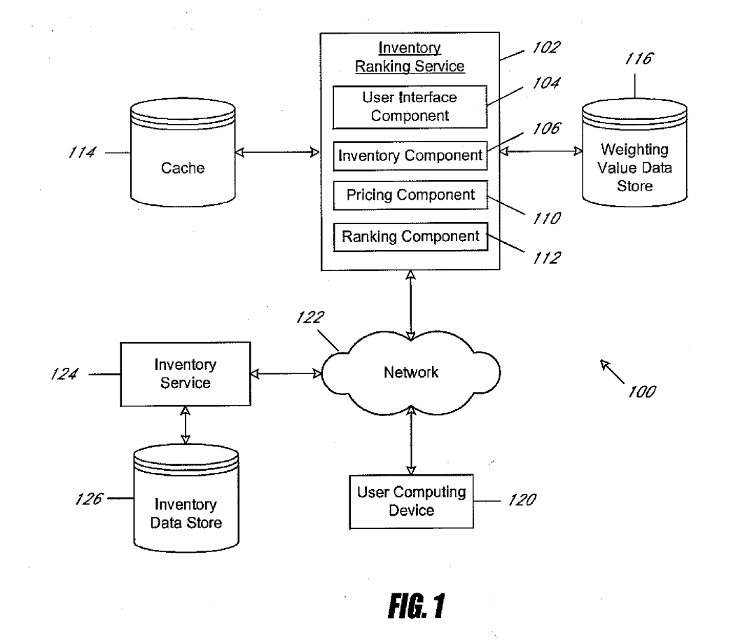

FIG. 1 presents an embodiment of an illustrative operating environment 100 that includes an inventory ranking service 102 for use in generating ranked groups of inventory items matching search criteria. The search criteria are received from a user computing device 120 in communication with the inventory ranking service 102 through a network 122. Upon receipt of the search criteria, the inventory ranking service 102 is configured to identify and obtain records of inventory items matching the search criteria and perform a ranking operation that ranks each of the identified inventory items with respect to each other. In order to rank the identified inventory items, the ranking operation calculates an inventory score for each of the identified inventory items based upon both the desirability of the inventory items, as reflected by attributes of the inventory items that are perceptible to users, as well as a margin, or profit, on the inventory items. As discussed below, ranking the identified inventory items in this manner generates a group of inventory items that is ordered both in terms of relevance to the received search criteria, as well as the profit provided by sale of the inventory items. In further embodiments, the group of ranked inventory items may be output to the user computing device 120.

The inventory ranking service 102 may be implemented by a single computing device, such as a server. However, those skilled in the art will appreciate that the inventory ranking service 102 may be embodied in a plurality of servers, each executing an instance of the inventory ranking service 102. The server may include a network interface, memory, processing unit, and computer readable medium drive, all of which may communicate with one another by way of a communication bus. The network interface may provide connectivity over the network 122 and/or other networks or computer systems. The processing unit may communicate to and from memory, which contains computer program instructions that the processing unit executes in order to operate the inventory ranking service 102. The memory generally includes RAM or ROM and/or other persistent and auxiliary memory.

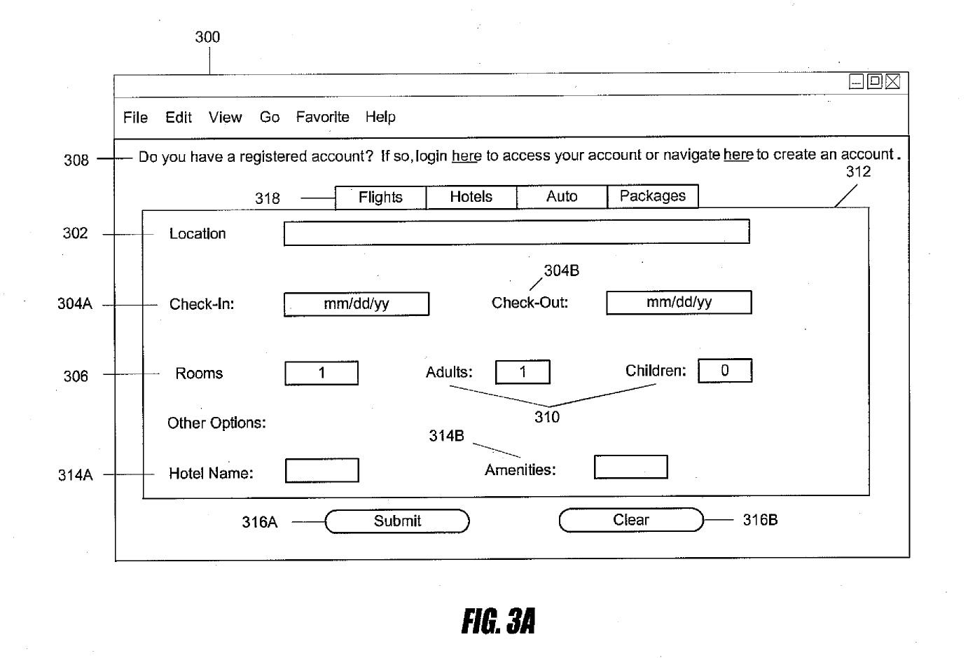

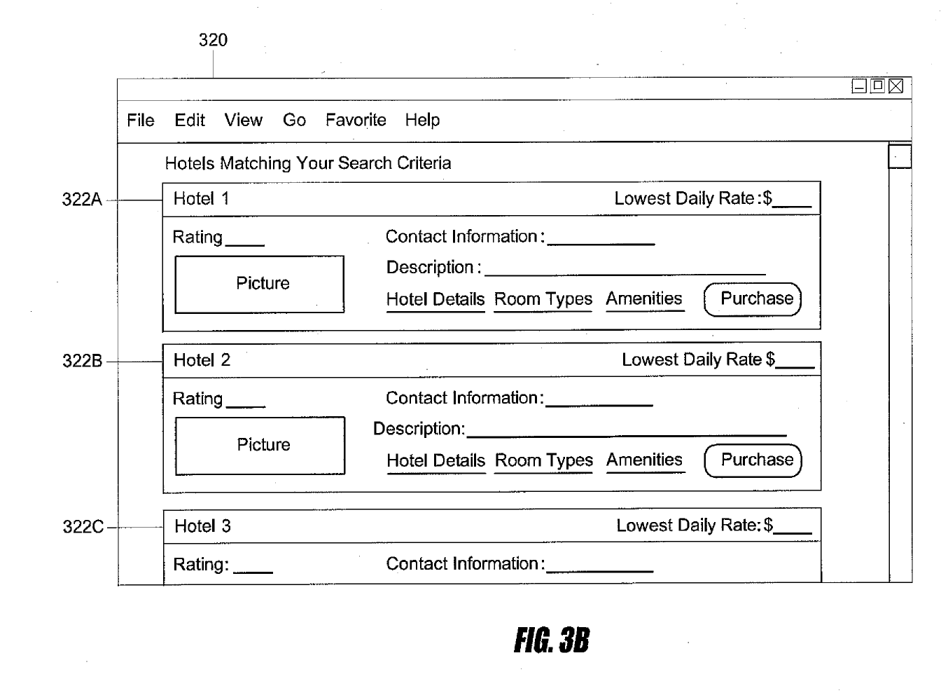

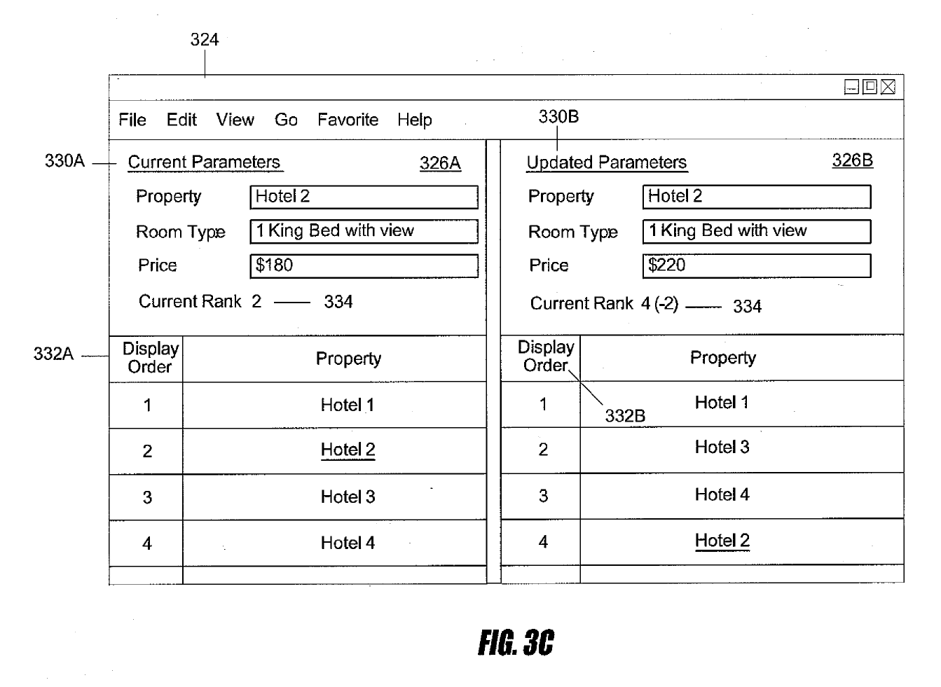

For example, in one embodiment, the memory may include a user interface component 104 that generates user interfaces and/or instructions, such as those illustrated in FIGS. 3A-3C. In one aspect, users may employ user computing devices 120 in order to interact with the ranking service 102 via user interfaces generated by the user interface component 104. For example, users may employ the user interfaces to send search criteria to the ranking service 102, review ranked inventory groups received from the ranking service 102, and/or purchase items provided in the ranked inventory groups.

Additionally, the ranking service 102 may enable a user to create a user account that distinguishes the user during access of the ranking service 102. Such a distinguishable, or registered user may further designate one or more user attributes that may be associated with the user. Examples may include, but are not limited to, membership numbers (e.g., frequent flyer numbers, rewards club numbers), household income, size of household, favorite destinations, desired destinations, contact information, and the like. Thus, by identifying a user account, the user's attributes may be identified.

As illustrated in FIG. 1, the user computing device 120 may include one or more hardware or software components capable of receiving user interfaces generated by the user interface component 104. The user interfaces may be used to input inventory search criteria to the ranking service 102 and receive the ranked inventory group matching the inventory search criteria. The user computing device 120 may be further capable of employing the user interfaces generated by the user interface component 104 for purchase of one or more inventory items from the ranked group of inventory items. The user computing device 120 may include, but is not limited to, personal computers, laptop computers, landline telephones, mobile phones, terminals, set top boxes, video game players, and personal digital assistants.

In alternative embodiments, the user computing device 120 may further include bots. Bots are computer programs configured to operate over networks, such as the network 122, and may employ automated scripts for performing routine tasks, such as retrieving, analyzing, and storing information. For example, the user computing device 120 may include one or more bots that send search criteria to the user computing device 120 and receive ranked inventory groups matching the search criteria. Such bots may further store the received, ranked inventory group and/or transmit the ranked inventory group to another user computing device 120.

As further illustrated in FIG. 1, the network 122 is the Internet, in certain embodiments. In other embodiments, however, the network 122 may be a Personal Area Networks (PAN), Local Area Network (LAN), Wide Area Network (WAN), landline telephone network, cellular telephone network, cable network, satellite network, and combinations thereof. In addition, the network 122 may be a wired network, a wireless network, or any combination thereof. As protocols for network communication, such as TCP/IP, are well known to those of skill in the art of computer networks, further description of these protocols and other methods used to implement the network are not provided here.

In one embodiment, the ranking service 102 may also include one or more software or hardware components capable of receiving search requests, retrieving information regarding inventory items matching the search requests, and calculating inventory scores for the identified inventory. Accordingly, the ranking service 102 may include the user interface component 104, as well as a pricing component 110, an inventory component 106, and ranking component 112. The ranking service 102 may further be in communication with one or more data stores, such as a cache 114 and a weighting value data store 116. The ranking service 102 may further be in communication with other services, such as inventory attribute service 124.

In one embodiment, the ranking component 112 may be configured to generate the inventory scores for identified inventory items and rank the identified inventory items into the ranked groups. The inventory score is a numerical value generated for each inventory item that represents the relative prominence that the inventory items should be accorded with respect to the other identified inventory items. In certain embodiments, the inventory score may be configured such that inventory items having higher inventory scores are accorded greater prominence than inventory items having lower inventory scores.

In one embodiment, the inventory score may be calculated according to Equation 1:

Inventory Scoreᵢ=Purchase Likelihoodᵢ*Marginᵢ (1)

where i is an index representing the inventory item, inventory scoreᵢ is the inventory score of the i^{th} inventory item, purchase likelihoodᵢ is the purchase likelihood of the i^{th} inventory item, and marginᵢ is the margin of the i^{th} inventory item.

The purchase likelihood for a selected inventory item represents the likelihood that a user would purchase the selected inventory item when presented with the choice of purchasing one or more inventory items from a group of inventory items that includes the selected inventory item. The margin represents the profit on the sale of the selected inventory item, or the difference between the price at which the selected inventory item is offered for sale and the cost of the inventory item.

The purchase likelihood for each inventory item may be calculated by employing a discrete choice model. Discrete choice models are designed to predict a decision made by an individual, such as a user of an inventory item, as a function of any number of variables. These models may be implemented by mathematical functions that predict choices based upon utility, or relative attractiveness, of competing alternative choices. Thus, the option having the greatest utility score is taken to represent a user's preferred choice and, therefore, has the highest purchase likelihood.

In one embodiment, the discrete choice model may employ a conditional logit model and regression techniques to determine the form of a utility function that mathematically describes the utility of a choice, for example, the selection of an inventory item. In one embodiment, the utility function may take the form of Equation 2:

utilityᵢ=exp(weight₁*attribute_{1,i}+weight₂*attribute_{2,i}+weightₖ*attribute_{k,i}) (2)

where k is an index representing an inventory attribute, utilityᵢ is the utility of the i^{th} inventory item, weightₖ is a weighting value corresponding to the kₜₕ inventory attribute, and attribute_{k,i} is the k^{th} inventory attribute value of the i^{th} inventory item.

In the context of the discrete choice model, the inventory attributes represent variables upon which a user may base a choice, such as a decision to purchase an inventory item, when presented with a range of inventory items from which to choose. As such, the inventory attributes represent characteristics of the inventory items that are common to the inventory items and perceptible to the user, while the inventory attribute values are numerical representations of the inventory attributes.

In one embodiment, the inventory attributes for an inventory item may include one or more of definitive measures, a perceived quality rating of the inventory item, and a perceived relative price. Examples of definitive measures may include, but are not limited to, price per room night. Examples of perceived quality of the inventory items may include, but are not limited to, industry opinion as characterized through a star rating. Examples of perceived relative price may include, but are not limited to, relative savings, as compared to other inventory items.

The weighting values may be a numerical representation of the importance of each inventory attribute with respect to the other inventory attributes being considered in the utility calculation. In certain embodiments, a weighting value higher than another may indicate that the inventory attribute associated with the higher weighting value is more important to the utility of the inventory item than the inventory attribute associated with a lower weighting value. For example, if the inventory attribute of price is of greater importance than the inventory attribute of perceived quality, the weighting value associated with price may be greater than the weighting value associated with perceived quality.

In one embodiment, the inventory attribute values are determined from the discrete choice model using training data. Training data are data sets that contain the attributes of inventory items and the actual decisions made by individuals when provided the choice between competing inventory items. Training data may include revealed preference data or stated preference data. Revealed preference data are data obtained by actual observation of choices, such as data mining the purchase data of individuals, or surveys of individuals that have already made a choice of inventory items. In contrast, stated preference data are data obtained by posing hypothetical questions to individuals and likely purchasers of inventory items in which the likely purchasers are asked to choose between inventory items having different inventory attributes.

Training data may be further classified by inventory item type and used to determine weighting values for the type of inventory items of interest. For example, training data gathered in the context of hotel lodging may provide a first set of weighting values for hotel lodging, while training data gathered in the context of automobile rentals may provide a second set of weighting values for automobile rentals. Notably, even if the inventory attributes for the two types of travel inventory items are the same, the first and second sets of inventory weighting values may be different, as the relative importance of each of the inventory attributes may be different for each inventory item type. For example, price may be more important to users of hotel lodging than users of automobile rentals and, therefore, the weighting value associated with the price attribute in hotel lodging may be greater than the weighting value associated with the price attribute in automobile rentals.

In further embodiments, the weighting values may be personalized to the user. If one or more attributes of users whose choices are contained within the training data set are known, the training data may be restricted to only to the choices of users having selected attributes. Examples of user attributes may include, but are not limited to, age, gender, education level, household income, race, ethnicity, and the like. By employing such a restricted training data set in the calculation of weighting values, the resultant weighting values may be more representative of the relative importance of the associated inventory attributes to users having the selected attributes than are weighting values calculated from the choices of all users within the training data set. Thus, the restricted training data set yields weighting values personalized to users having the selected attributes. The training data set may be restricted to users having any combination of users attributes, providing a variety of personalized weighting values from a single training data set.

Purchase likelihood for a selected inventory item may be calculated from the ratio of the utility value of the selected inventory item to the total utility for the group of inventory items from which the selected inventory item is chosen. The purchase likelihood may be mathematically represented according to Equation 3:

$$Purchase {Likelihood}_{i} = \frac{{utility}_{i}}{{\sum }_{i = 1}^{j} {utility}_{i}} \qquad ( 3 )$$

where utilityᵢ is the utility of the i^{th} inventory item, as calculated according to Equation 2, and j is the total number of inventory items within the group of inventory items from which the i^{th} inventory item is chosen. Thus, the purchase likelihood represents a utility value that is normalized by the total utility of all inventory items, including the inventory item under consideration.

Combining Equations 1 and 3, yields Equation 4, a representation of Equation 1 having the purchase likelihood written in terms of the utility:

$$Inventory {Score}_{i} = \frac{{utility}_{i}}{{\sum }_{i = 1}^{j} {utility}_{i}} * {m arg in}_{i} \qquad ( 4 )$$

In alternative embodiments, the inventory value may further include considerations regarding the inventory items that are not perceptible to the user and, therefore, are not accounted for in the calculation of purchase likelihood. These factors may be represented as a numerical value, referred to as a long term factor, or LTF, of the inventory item. For example, in embodiments pertaining to hotel lodging, the long term factor may include, but are not limited to, inventory availability, discounts provided in rate plans for inventory items, and customer treatment. In certain embodiments, the adjusted inventory score may be calculated as a sum of the inventory score and LTF, as illustrated in Equation 5:

$$Adjusted Inventory {Score}_{i} = \frac{{utility}_{i}}{{\sum }_{i = 1}^{j} {utility}_{i}} * m arg {in}_{i} + {LTF}_{i} \qquad ( 5 )$$

where LTFᵢ is the long term factor associated with the i^{th} inventory item. Thus, the long term factor may be used to generate an adjusted inventory score which is greater than or less than the inventory score.

For example, the long term factor may be employed to incentivize the behavior of users employing the ranking service 102. Assume that a seller offering inventory items for sale using the inventory ranking service 102 wishes to obtain high turnover rates in their inventory items. Given this goal, the long term factor may be configured such that it increases in a selected manner with the duration that inventory items have been in inventory. As the time an inventory item is held in inventory increases, the long term factor increases and, in turn, increases the adjusted inventory score of the inventory item. The increased ranking of the inventory item, in turn, may result in the inventory item being positioned in the ranked inventory group for greater prominence with respect to inventory items that have been held in inventory for a shorter period of time and, in turn, yield a higher purchase rate of long held inventory items.

The ranking component 112 may communicate with the inventory component 106 of the ranking service 102 to obtain the identified inventory. The inventory component 106 is configured to analyze the search criteria received by the ranking service 102 and retrieve records of inventory items matching the search criteria. In one embodiment, analysis performed by the inventory component 106 may include identifying an inventory type to which the search criteria pertain. For example, such identification may be made from one or more selections provided with the search criteria received from the user computing device 120. In other embodiments, the analysis performed by the search inventory component 106 may include reviewing received search criteria to determine whether the search criteria are sufficient to enable the identification of matching inventory items, based upon the type of inventory being requested. If the inventory search criteria are insufficient to identify matching inventory items, the inventory component 106 may instruct the user interface component 106 to generate an interface that requests additional search criteria from the user computing device 120.

If the inventory search criteria are sufficient to identify matching inventory items for the type of inventory items being requested, the inventory search criteria are submitted to an inventory service 124 that is in communication with an inventory data store 126 and the network 122. The inventory service 124 employs programmed logic to search inventory item records for the pertinent inventory type maintained by the inventory data store 126 and to identify records of inventory items that most closely match the search criteria. The identified inventory may be returned to the ranking service 102 for use by the ranking component 112 in calculating the inventory score or adjusted inventory score.

The inventory service 124 may further provide the ranking service 102 with one or more inventory attribute values for the identified inventory items. The inventory attribute values, like the inventory item records, may be maintained by the inventory data store 126 for retrieval in response to requests from the network 112. In certain embodiments, the inventory service 124 may periodically receive updated inventory attribute values for inventory items and, between updates, the attribute service may provide the most recent inventory attribute values stored by the inventory data store 126. In other embodiments, the inventory service 124 may receive updated inventory attribute values for inventory items on a continuous basis but provide an aggregated inventory attribute value, such as an average over a selected period of time. In further embodiments, the inventory service 124 may receive inventory attribute values on a continuous basis and provide the most recently received inventory attribute values.

The inventory service 124 may also provide the ranking service 102 with one or more rate plans associated with the identified inventory. Rate plans may reflect generally available or negotiated schedules of prices that the ranking service 102 is charged for the inventory items. The rate plans may depend on variables including, but not limited to, the volume of inventory items purchased and the duration and/or dates of purchase (e.g., for rental inventory items).

The ranking component 112 may communicate with the pricing component 110 of the ranking service 102 to obtain the margin for the identified inventory. The pricing component 110 is configured to calculate the margin according to a difference between the price at which the inventory item is to be offered for sale and the cost to obtain the inventory item. In one embodiment, the cost to obtain the inventory item may be determined from rate plans received from the inventory service 124 by input of any required variable values, such as location, date, duration, and the like, into the rate plan. The variable values may be obtained from the search criteria received from the user computing device 120. In the circumstance that one or more required variable values is not available, the pricing component 110 may instruct the user interface component 104 to generate an interface that requests the missing variable values from the user computing device 120.

The price at which an inventory item is to be offered for sale may be further determined by the pricing component 110 using any of a variety of pricing plans. In one embodiment, the price may be calculated as a fixed percentage of the cost. In another embodiment, the price may be calculated as a function of the purchase likelihood, where the price function is configured such that inventory items having a higher purchase likelihood are offered at a higher price, taking advantage of the expected higher demand.

In alternative embodiments, the ranking component 112 may communicate with the cache 114 to obtain the inventory attributes and margins associated with one or more inventory items satisfying the search criteria. The cache 114 represents a data store that stores records of search criteria previously submitted to the ranking service 102 and the corresponding information obtained by the ranking service 102 in order to provide a ranked group of inventory items in response to receipt of the search criteria. Thus, by identifying that the cache 114 contains information regarding inventory items identified from a previously submitted search request having the same search criteria, the ranking component 112 may obtain, from the cache 114, the associated margins and/or inventory attributes. By retrieving margin and/or inventory item attribute values from the cache 114, as opposed to the pricing component 110 and inventory service 124, time and computational resources may be saved by avoiding repetition of queries and calculations already performed.

In certain embodiments, the ranking service 102 may disregard inventory item information from the cache 114. This option reflects the fact that inventory attributes and rate plans, as well as the availability of the inventory items themselves, may change periodically and become invalid unless updated. For example, cached inventory item information may be disregarded after a selected time period, such as a duration greater than or about equal to the frequency with which the inventory attributes are updated in the inventory service 124. In other embodiments, the ranking service 102 may disregard inventory item information, such as inventory attributes and/or rate plans, which are different than those obtained from the inventory service 124.

The ranking component 112 may communicate with the weighting value data store 116 in order to retrieve weighting values associated with the inventory attribute values of the identified inventory. The weighting values may include, e.g., weighting values determined from users in aggregate, personalized weighting values from users having selected user attributes, and combinations thereof. In further embodiments, the weighting value data store may further maintain weighting values that are personalized to users having selected user attributes.

In other embodiments, a training data set may be stored by the weighting value data store 116 and the ranking component 112 may employ the training data set to calculate the weighting values in real time, rather than retrieving stored values. For example, in cases where personalized weighting values pertinent to selected attributes of a user accessing the ranking service 102 through the user computing device 120 are desired, but not available, for use in calculating the inventory score, the ranking component 110 may restrict the training data set and calculate the weighting values using the discrete choice model.

In FIG. 1, the cache 114 and weighting value data store 116 are illustrated as being in direct communication with the ranking service 102. In alternative embodiments, the cache 114 and weighting value data store 116 may be accessed by the ranking service 102 through the network 122. In further embodiments, more than one of the cache 114, weighting value data store 116, and inventory service 124 and/or inventory data store 126 may be present in the operating environment 100. For example, a plurality of inventory data stores 126 may be present in the operating environment, with each inventory data store containing records of inventory items of a certain type, such as available inventory of hotel lodging, airplane flights, automobiles for rent, and the like.

The operating environment 100 illustrated in FIG. 1 is presented as a distributed computing environment including several computer systems that are interconnected using one or more computer networks. However, it will be appreciated by those skilled in the art that the operating environment 100 could have fewer or greater components than are illustrated in FIG. 1. For example, the operating environment 100 could include various web services components and peer-to-peer network configurations. Thus, the depiction of the operating environment 100 in FIG. 1 should be taken as illustrative and not limiting to the present disclosure.

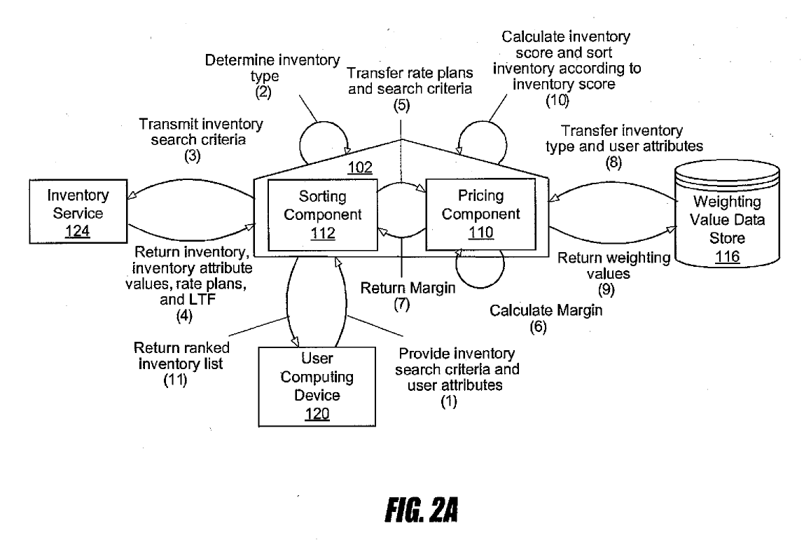

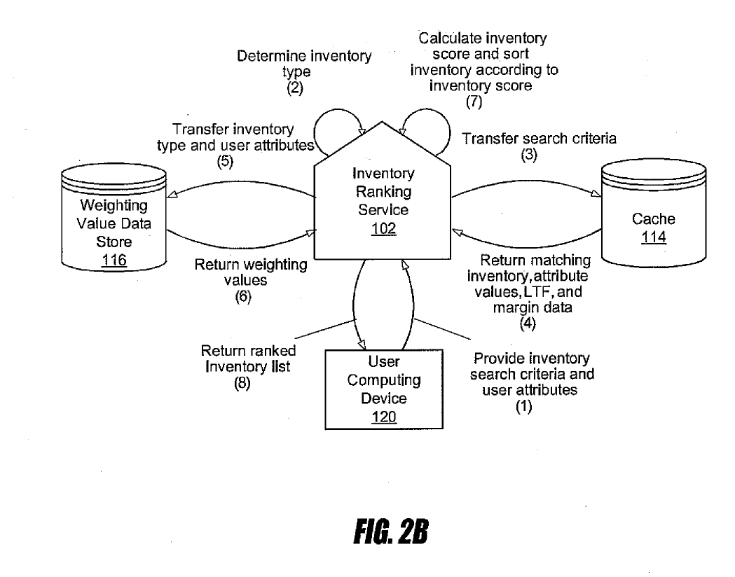

FIGS. 2A and 2B are block diagrams of embodiments of the operation of the ranking service 102 within the operating environment of FIG. 1. FIGS. 2A and 2B are further discussed in connection with FIGS. 3A-3C, which illustrate embodiments of user interfaces generated by the user interface component 104 for display to the user during the inventory search and ranking operations.

FIG. 3A illustrates one embodiment of a user interface 300 that may be employed by the user computing device 120 for entry of search criteria to be received by the ranking service 102. In one example, the user interface 300 may be configured for performing searches on travel inventory. The user interface 300 may include a prompt 308 or entry space that allows a user to login to a previously created account or register a new account. During the account creation process, the user may enter attributes about himself or herself that are subsequently linked to the account. Subsequently, use of the user interface 300 to input search criteria to the ranking service 102 may further provide the ranking service 102 with one or more of the user's attributes. As discussed below, this information may allow inventory items identified and ranked by the ranking service 102 to be ranked based upon personalized weighting values, potentially increasing the relevance of the top ranked inventory items to the user.

The user interface 300 may be further employed to identify the type of inventory items to which the search criteria to be entered in the user interface 300 pertain. A plurality of selection buttons 318 may also be present within the user interface 300, allowing the user to identify the inventory item type by selection of one of the selection buttons 318. For example, user interface 300 may have selection buttons 318 pertaining to inventory item types such as flights, hotels, automobiles, and combinations thereof. Combinations of inventory items may also be referred to as packages.

When designating the inventory item type, the user interface 300 may further dynamically update a search criteria entry window 312. The updated window 312 may include fields for the entry of search criteria that are necessary to perform the search. For example, when designating a search for hotel inventory with the selection buttons 318, fields for search criteria such as location 302, check-in and check-out dates 304A, 304B, the number of rooms 306 desired, and of the entry of number of adults and children 310 may be made available within the window 312. The updated window 312 may further include fields for the entry of search criteria that are optional to perform the search, such as a specific hotel name 314A and desired amenities 314B. After entry of the search criteria in the user interface 300, the user may submit the search criteria to the ranking service by selection of a submission button 316A or restart their entry of search criteria by selection of a clear button 316B.

After submission of the search criteria in the user interface 300, a request for inventory items may be transmitted to the inventory ranking service 102 (FIG. 2A). The request may contain the entered inventory search criteria and, optionally, one or more user attributes associated with the user account. Upon receipt of the request, the inventory ranking service 102 may determine the type of inventory item and transmits inventory search criteria to the inventory service 124 that contains inventory records for the determined inventory type. In response, the inventory service 124 returns inventory records satisfying the search criteria to the inventory ranking service 102, as well as corresponding inventory attributes, rate plans, and long term factors. In certain embodiments, the information received from the inventory service may be retained by the ranking component 112.

The ranking service 102 further may further employ the pricing component 110 to obtain the margin. The rate plans and search criteria, such as duration of stay, in the case of hotel inventory, may be transferred to the pricing component 112. Based upon the dates and duration of stay and the rate plan, the pricing component 110 may calculate the cost of each of the inventory items. The pricing plan 110 may also employ pricing rules to determine the price at which the inventory items are offered, such as a selected percentage of the cost. The margin may be calculated by the pricing component 110 as difference between the price and cost of the inventory items and returned to the ranking component 112.

The ranking service 102 further queries the weighting value data store 116 to obtain the weighting values. In one embodiment, the inventory type previously determined by the ranking service 102 is transmitted to the weighting value data store 116 and, based upon this inventory type, weighting values corresponding to the inventory type may be returned to the ranking service 102. In other embodiments, both the inventory type and user attributes determined from the submitted search criteria may be transmitted to the weighting value data store 116. With the user attributes, weighting values personalized to one or more of the user attributes may be identified, if present, and returned to the ranking service 102.

Having obtained the inventory attribute values, weighting values, margin, and, optionally, long term factors, the ranking service 102 may proceed to calculate the inventory score for each identified inventory item and rank the inventory items according to the inventory score. For example, the inventory items may be ranked in descending order of inventory score. The ranked inventory group may be further returned to the user computing device 120 in a user interface 320, as illustrated in FIG. 3B.

The user interface 320 may include a plurality of inventory items, such as hotel inventory 322A, 322B, 322C, and one or more selected attribute values corresponding to the inventory items, such as a rating, daily rate, amenities, and the like. The user interface 320 may further allow the user to select one or more of the displayed inventory items for purchase.

In alternative embodiments, illustrated in FIG. 2B, the inventory ranking service 102 may employ the cache 114 to obtain the margin, inventory attributes, and long term factors for inventory items matching the search criteria. As discussed above, the inventory search criteria, and optionally the user attributes, are provided to the inventory ranking service 102 in a request for inventory items. The type of inventory being requested is determined and the search criteria are sent to the cache 114. The cache 114 receives the search criteria and searches its stored records to determine if a request containing the same search criteria had been previously responded to by the inventory ranking service 102. If so, the cache 114 returns the margin, inventory attributes, and long term factors for inventory items matching the search criteria obtained for the previous search to the ranking service 102 for calculation of the inventory score and ranking of inventory items. If not, the cache informs the inventory ranking service 102 of this fact and the margin, inventory attributes, and long term factors for inventory items matching the search criteria are then obtained as discussed above with respect to FIG. 2A.

FIG. 3C presents an embodiment of another illustrative user interface 324 that may be provided to the user computing device 120 by the ranking service 102. The user interface 324 may be employed to examine how changes in parameters employed in the inventory score calculation (e.g., margin, inventory attributes, weighting values, LTF) may influence the ranking of inventory items. For example, the user interface 324 may include a first pane 326A that illustrates a ranked group 332A of each identified inventory item as output by the ranking service 102 using current parameters 330A. The user interface 324 may further include a second pane 326B that illustrates a modified ranked group 332B employing updated parameters 330B for the selected inventory item. The user interface 324 may further provide the current ranking number 334 before and after the change of parameters. In certain embodiments, the user interface 324 may be available for use only to selected users, such as an operator of the ranking service 102, and not users in the general public.

Beneficially, the user interface 324 may provide a valuable tool for determining whether the ranking performed by the ranking service 102 is adequate or may require manual override. For example, in the context of hotel inventory, the user interface 324 may be employed to identify how much the price of a selected property would need to increase before moving down a selected number of ranks. In another example it may be desired that hotels owned by a given company only appear a selected number of times within the ranked inventory group. If the ranked group 332A of inventory items displayed using the current parameters 330A does not satisfy this goal, the long term values for selected inventory items may be adjusted so as to achieve the desired goal.

### EXAMPLES

The following non-limiting examples present an illustration of generating and using training data to determine weighting values and how those weighting values may be used by the inventory ranking service 102 with inventory attribute values, margins, and long term factors to calculate inventory scores and adjusted inventory scores for the ranking of inventory items. It may be understood that the examples are presented for illustrative purposes and should not be construed to limit the scope of the disclosed embodiments.

### Example 1

### Generation of Training Data

Assume that observations are made regarding purchasing choices with respect to a first hotel and a second hotel. In a first case, the first hotel possesses the attributes of a 1-star rating and a daily rate of $100, while the second hotel possesses the attributes of a 2-star rating and a daily rate of $100. Assuming that any other attributes of the first and second hotels are the same, except for the star rating, and the buyer chooses the second hotel for lodging, it may be concluded that a 2-star rating is preferred to a 1-star rating.

Consider a second case that is kept constant with respect to the first case, except that that the daily rate of the second hotel is increased from $100 to $120. If the user still chooses the second hotel for lodging, then it may be concluded that an extra 1-star is worth at least $20 to the buyer. By repeating this exercise, increasing the daily rate of the second hotel while keeping all other attributes of the first and second hotels constant and observing the choices that users make, the training data set may be generated.

Further assume that, in this manner, it is learned that users only switch their selection of hotel from the second hotel to the first hotel when the price of the second hotel increases from $140 to $141. Therefore, it may be concluded that each star rating is worth 40 and each dollar of the daily rate is worth −1 for both the first and second hotels. These estimates of worth are the weighting values. With this information, the training data set of Table I may be generated, where i=1 for the first hotel and i=2 for the second hotel, the star rating is hotel attribute_{1,i} and the daily rate is hotel attribute_{2,i}.

TABLE I
Example Training Data Set

| | i | weight₁ | attribute_{i,1} | weight₂ | attribute_{i,2} |
|---|---|---|---|---|---|
| First Hotel | 1 | 40 | 1 | −1 | 2 |
| Second Hotel | 2 | 40 | 100 | −1 | 141 |

### Example 2

### Calculation of Utility, Purchase Likelihood, and Inventory Score

Mathematically, the utility function for the two hotels may be written according to Equation 2 using the training data of Table I as:

First Hotel, i=1:

Utility₁=exp(weight₁*attribute_{1,1}+weight₂*attribute_{2,1})

Utility₁=exp(40*star rating₁−1*daily rate₁)

Utility₁=exp(40*1−1*100)=exp(40−100)=exp(−60)

Utility₁=8.7*10⁻²⁷

Second Hotel, i=1:

Utility₂=exp(weight₁*attribute_{1,2}+weight₂*attribute_{2,2})

Utility₂=exp(40*star rating₂−1*daily rate₂)

Utility₂=exp(40*2−1*141)=exp(80−141)=exp(−61)

Utility₂=3.2*10⁻²⁷

Thus, it may be seen that the utility function numerically captures the observation of the training data that the utility of the second hotel is equal to or greater than the utility of the first hotel until the daily rate of the second hotel exceeds $140. By adding more inventory attributes, a utility function valuing all the inventory attributes may be derived, provided that a training data set having sufficient observations may be obtained.

The purchase likelihood is calculated according to Equation 3:

$$First Hotel , i = 1 \text{:}$$

$$Purchase {Likelihood}_{1} = \frac{{utility}_{1}}{{utility}_{1} + {utility}_{2}}$$

$$\begin{matrix}Purchase {Likelihood}_{1} = \frac{8.7 * {10}^{- 27}}{8.7 * {10}^{- 27} + 3.2 * {10}^{- 27}} \\ = \frac{8.7 * {10}^{- 27}}{11.9 * {10}^{- 27}}\end{matrix}$$

$$Purchase {Likelihood}_{1} = 0.731$$

$$Second Hotel , i = 2 \text{:}$$

$$Purchase {Likelihood}_{2} = \frac{{utility}_{2}}{{utility}_{1} + {utility}_{2}}$$

$$\begin{matrix}Purchase {Likelihood}_{2} = \frac{3.2 * {10}^{- 27}}{8.7 * {10}^{- 27} + 3.2 * {10}^{- 27}} \\ = \frac{3.2 * {10}^{- 27}}{11.9 * {10}^{- 27}}\end{matrix}$$

$$Purchase {Likelihood}_{2} = 0.269$$

It may be observed that the purchase likelihood value of Hotel 1 is greater than Hotel 2 in this case, as the utility of Hotel 1 is greater than Hotel 2.

Assume that there are no long term factors to consider and the margin of both Hotel 1 and Hotel 2 is $50. The inventory score for each hotel is calculated according to Equation 1 or 4:

First Hotel, i=1:

Inventory Score₁=Purchase Likelihood₁*Margin₁

Inventory Score₁=0.731*50

Inventory Score₁=36.55

Second Hotel, i=2:

Inventory Score₂=Purchase Likelihood₂*Margin₂

Inventory Score₂=0.269*50

Inventory Score₂=13.45

As the margins are taken to be the same between the first and second hotels, the inventory score is observed to follow the same trend as that of the purchase likelihood, with Hotel 1 having a greater inventory score than Hotel 2. Thus, a ranked group of hotels including Hotel 1 and Hotel 2 would group Hotel 1, first, followed by Hotel 2. It may be further observed that, in order for the inventory score of Hotel 2 to exceed that of Hotel 1, the margin of Hotel 2 would need to be over 2.7 times greater than its present value, or greater than $135, absent consideration of long term factors.

In summary, embodiments are disclosed for the ranking of inventory items identified to satisfy selected search criteria. An inventory score may be calculated as a function of inventory attribute values perceptible to a user, corresponding weighting values, and margins for each of the identified inventory items using a discrete choice model employing a conditional logit function. In one embodiment, the inventory score is employed to rank the inventory items, which may be further displayed to a user for consideration and possible purchase. Long term factors may further be introduced into the inventory score calculation to account for additional considerations that are not perceptible to the user and, therefore, not accounted for in the attribute values.

Ranking the identified inventory items according to the inventory score may enable the presentation of the search results in a manner favorable to both the user and the seller. For example, inventory items that possess a relatively high margin and high purchase likelihood are displayed with relatively high prominence, while inventory items having a relatively low margin and low purchase likelihood are displayed with relatively low prominence to the user. In this manner, users first view inventory items that are highly likely to result in purchase, owing to the high purchase likelihood of the inventory item, as well as relatively high profit on the sale of the item, owing to the high margin for the inventory item. Thus, the user benefits by receiving highly relevant inventory items towards the beginning of the returned search results, saving them time and frustration in the purchasing process, while the seller benefits from the sale of relatively high margin inventory items.

Embodiments of the present disclosure have been described with reference to the drawings. As will be recognized, many of the features embodied within the disclosed systems and methods may be implemented or used without others. Numerous implementation details have been set forth in the description in order to illustrate, but not limit, the disclosure.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language, such as, among others, “can,” “could,” “might,” or “may,” unless specifically stated otherwise, or otherwise understood with the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features elements, and/or steps are included or are performed in any particular embodiment.

Any process descriptions, elements, or blocks in the flow diagrams described herein, and/or depicted in the attached figures, should be understood as potentially representing modules, segments, or portions of code which include one or more executable instructions for implementing specific logical functions or steps in the process. Alternative implementations are included within the scope of the embodiments described herein which elements or functions which may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system for ranking inventory, the system comprising:
a data store that stores weighting values corresponding to hotel attributes having an influence on the purchase of lodging in hotels; and
a computing device in communication with the data store, the computing device operative to:
receive one or more search criteria relating to hotels;
identify one or more hotels that satisfy the search criteria;
generate an inventory score for each of the one or more identified hotels as a function of their respective weighting values and hotel attribute values that quantify the hotel attributes, wherein the inventory score is representative of a likelihood of purchasing lodging in the hotel; and
provide a group of the one or more identified hotels, wherein the group is ranked according to the generated inventory scores.

2. The system of claim 1, wherein the generated inventory score is further generated as a function of a margin per room night.

3. The system of claim 2, wherein the generated inventory score is further generated as a function of a long term factor representative of at least one hotel attribute that is not perceptible by a user making a hotel purchase decision.

4. The system of claim 1, wherein at least one hotel attribute comprises a feature of the hotel that is perceptible by a user making a hotel purchase decision.

5. The system of claim 1, wherein at least one weighting value is determined from training data that is fit to a discrete choice model employing a conditional logit function.

6. A computer implemented method for ranking inventory items retrieved from one or more inventory stores, the method comprising:
identifying inventory items that satisfy one or more search criteria;
obtaining an inventory attribute value, attribute weighting value, and margin for each of the identified inventory items, wherein the inventory attribute value comprises a numerical representation of an attribute of the inventory item that is perceivable by a user and that influences the user's likelihood of purchasing the inventory item;
determining an inventory score for each of the identified inventory items as a function of their respective inventory attribute value, attribute weighting value, and margin; and
ranking the identified inventory according to the determined inventory score.

7. The computer implemented method of claim 6, wherein the inventory attribute comprises at least one of a price of the inventory item and a rating of the inventory item.

8. The computer implemented method of claim 6, wherein the attribute weighting value is determined from training data comprising individual inventory item selection choices that are fit to a discrete choice model employing a conditional logit function.

9. The computer implemented method of claim 8, wherein the training data comprise inventory item selection choices made by a plurality of users sharing at least one selected attribute with a user that provides the search criteria.

10. The computer implemented method of claim 6, further comprising determining a purchase likelihood for each inventory item as a function of the inventory attribute and attribute weighting value for the inventory item.

11. The computer implemented method of claim 10, wherein the purchase likelihood represents a user preference for purchasing an inventory item from the identified inventory items when provided the choice of the identified inventory items.

12. The computer implemented method of claim 10, wherein the inventory score comprises the product of the purchase likelihood and the margin.

13. The computer implemented method of claim 12, wherein the inventory score further comprises a long term factor representing at least one inventory attribute that is not perceptible by user making an inventory purchase decision.

14. The computer implemented method of claim 13, wherein the inventory score comprises the sum of the long term factor, and the product of the purchase likelihood and the margin.

15. The computer implemented method of claim 6, wherein the margin is retrieved from a cache that stores margins determined for inventory items that satisfy the one or more search criteria.

16. The computer implemented method of claim 6, wherein the inventory items comprise lodging inventory.

17. The computer implemented method of claim 16, wherein the search criteria comprise at least one of a date range for and a location of the lodging inventory.

18. The computer implemented method of claim 6, wherein the inventory items comprise automobile inventory.

19. The computer implemented method of claim 6, wherein the inventory items comprise a package including one or more of lodging inventory, automobile rental inventory, air travel inventory, and cruise inventory.

20. A computer-readable medium having a computer-executable component for ranking inventory items, the computer-executable component comprising:
a pricing component that is operative to determine a margin for each of a group of inventory items that satisfy one or more search criteria; and
a ranking component that is operative to:
obtain inventory attribute values that quantify selected inventory attributes of the inventory items that are perceptible to a user of the inventory items;
obtain attribute weighting values corresponding to the inventory attributes that represent the relative importance of the inventory attributes as compared to one another; and
determine a ranking of each of the inventory items in the group of inventory items according to an inventory score determined as a function of the inventory attribute values and attribute weighting values.

21. The computer-readable medium of claim 20, wherein the inventory items comprise lodging inventory.

22. The computer-readable medium of claim 20, wherein the inventory items comprise automobile inventory.

23. The computer-readable medium of claim 20, wherein the inventory items comprise a package including one or more of lodging inventory, automobile rental inventory, air travel inventory, and cruise inventory.

24. The computer-readable medium of claim 20, wherein the search criteria comprise at least one of a date range for and a location of the inventory items.

25. The computer-readable medium of claim 24, wherein the pricing component is further operative to:
obtain a rate plan for each of the inventory items that specifies the price of the inventory as a function of time;
obtain the cost to provide each of the inventory items as a function of time; and
determine the margin for each of the inventory items from the price and cost during the date range.

26. The computer-readable medium of claim 20, further comprising a user interface component that generates at least one user interfaces enabling input of the search criteria and output of the ranked inventory items.

27. The computer-readable medium of claim 20, wherein the inventory score given by:
$$Inventory {Score}_{i} = \frac{{utility}_{i}}{{\sum }_{i = 1}^{j} {utility}_{i}} * m arg {in}_{i}$$
wherein i is an index representing an inventory item within the group of inventory items, j is the total number of inventory items within the group of inventory items, utility/is the utility of the i^{th} inventory item, and marginᵢ is the margin of the i^{th} inventory item; and
wherein utilityᵢ is given according to:
Utilityᵢ=exp(weighting₁*attribute_{1,i}+weighting₂*attribute_{2,i}+ . . . weightingₖ*attribute_{k,i})
wherein k is an index representing the inventory attribute, weightingₖ is the weighting value corresponding to the k^{th} inventory attribute, and attribute_{k,i} is the k^{th} inventory attribute value of the i^{th} inventory item.

28. The computer-readable medium of claim 27, wherein the attribute weighting values are determined from training data comprising individual inventory item selection choices that are fit to a discrete choice model employing a conditional logit function.

29. The method of claim 28, further comprising a user interface component that is operative to identify a user that submits the search criteria and wherein the training data are selected so as to comprise inventory item selection choices made by a plurality of users sharing at least one selected attribute with the user.

30. The computer-readable medium of claim 27, wherein the ranking is determined according to an inventory score given by:
$$Inventory {Score}_{i} = \frac{{utility}_{i}}{{\sum }_{i = 1}^{j} {utility}_{i}} * m arg {in}_{i} + {LTF}_{i}$$
wherein LTFᵢ is a long term factor of the i^{th} inventory item that comprises a numerical representation of at least one inventory attribute value that is not perceptible by user making a inventory purchase decision.

31. A system for ranking inventory, the system comprising:
a data store that stores weighting values corresponding to inventory attributes having an influence on the purchase of inventory items; and
a computing device in communication with the data store, the computing device operative to:
identify one or more inventory items that satisfy search criteria;
generate an inventory score for each of the one or more identified inventory items as a function of their respective weighting values and inventory attribute values that quantify the inventory attributes, wherein the inventory score is representative of a likelihood of purchasing the inventory items; and
rank the identified inventory items into a ranked inventory group according to the generated inventory scores.

32. The system of claim 31, wherein the computing device is further operative to determine a margin for each of the identified inventory items.

33. The system of claim 32, wherein the generated inventory score comprises the product of the margin and a purchase likelihood.

34. The system of claim 33, wherein the purchase likelihood represents a user preference for purchasing an inventory item from the identified inventory items when provided the choice of the identified inventory items.

35. The system of claim 33, wherein the inventory score given by:
$$Inventory {Score}_{i} = \frac{{utility}_{i}}{{\sum }_{i = 1}^{j} {utility}_{i}} * m arg {in}_{i}$$
wherein i is an index representing an inventory item within the group of inventory items, j is the total number of inventory items within the group of inventory items, utility/is the utility of the i^{th} inventory item, and marginᵢ is the margin of the i^{th} inventory item; and
wherein utilityᵢ is given according to:
Utilityᵢ=exp(weighting₁*attribute_{1,i}+weighting₂*attribute_{2,i}+weightingₖ*attribute_{k,i})
wherein k is an index representing the inventory attribute, weightingₖ is the weighting value corresponding to the k^{th} inventory attribute, and attribute_{k,i} is the k^{th} inventory attribute value of the i^{th} inventory item.

36. The computer-readable medium of claim 35, wherein the ranking is determined according to an inventory score given by:
$$Inventory {Score}_{i} = \frac{{utility}_{i}}{{\sum }_{i = 1}^{j} {utility}_{i}} * m arg {in}_{i} + {LTF}_{i}$$
wherein LTFᵢ is a long term factor of the i^{th} inventory item that comprises a numerical representation of at least one inventory attribute value that is not perceptible by user making a inventory purchase decision

37. The system of claim 35, wherein the attribute weighting values are determined from training data comprising individual inventory item selection choices that are fit to a discrete choice model employing a conditional logit function.

38. The system of claim 37, wherein the training data are selected so as to comprise inventory item selection choices made by a plurality of users sharing at least one selected attribute with the user.

39. The system of claim 31, wherein the computing device is further operative to output the ranked inventory group to a user.

40. The system of claim 31, wherein the inventory items comprise lodging inventory.

41. The system of claim 31, wherein the inventory items comprise automobile inventory.

42. The computer-readable medium of claim 31, wherein the inventory items comprise a package including one or more of lodging inventory, automobile rental inventory, air travel inventory, and cruise inventory.
